(19) United States
(12) Patent Application Publication
(10) Pub. No.: US 2004/0228474 A1
(43) Pub. Date: Nov. 18, 2004

(54) Echo-canceling apparatus, an echo-canceling method, a program and a recording medium

(75) Inventors: Kenichi Taniguchi, Fukuoka-shi (JP); Naoto Kawasaki, Kasuga-shi (JP); Hideaki Sasaki, Onojyo-shi (JP); Junichi Koga, Fukuoka-shi (JP); Kenyu Yamashita, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/798,976

(22) Filed: Mar. 12, 2004

(30) Foreign Application Priority Data
Mar. 12, 2003 (JP) P. 2003-066481

(51) Int. Cl. H04M 9/08

(52) U.S. Cl. 379/406.12; 379/406.14

(57) ABSTRACT

Echo-canceling apparatus of the invention includes transfer function estimation unit which estimates a transfer function corresponding to the reverberation of a room attached to a voice after it is output from a loudspeaker and before it is input to a microphone, a first filter unit which operates using the transfer function, a first subtraction unit which subtracts the output signal of the first filter unit from the signal from the microphone, a second filter unit which operates using the transfer function copied from the first filter unit in case the estimation accuracy of the transfer function estimation unit is high, a second subtraction unit which subtracts the output signal of the second filter unit from the signal from the microphone, a singing detection unit which detects singing, a notch filter unit which notches a specific frequency band component in the signal received from a far-end speaker, and a switch unit which selects between the signal from the far-end speaker processed by the notch filter unit and the signal from the far-end speaker not processed by the notch filter unit.

### BACKGROUND OF THE INVENTION

1. Field of the invention

The present invention relates to echo-canceling apparatus comprising a loudspeaker which outputs a received voice from a far-end speaker, a microphone to which the voice of a near-end speaker is input, and a central processing unit (CPU) which controls the whole system, an echo-canceling method for the echo-canceling apparatus as well as a program for the echo-canceling apparatus and a computer-readable recording medium on which the program is recorded.

2. Description of the related art

Voice hands-free apparatus such as a speaker-phone telephone set employs an echo cancellation technique in order to prevent singing and acoustic echo. According to the acoustic echo cancellation technique, from the voice output from a loudspeaker and input as an acoustic echo to a microphone via an acoustic echo path such as a room, the echo replica synthesized in accordance with the echo characteristic is subtracted to substantially cancel the echo.

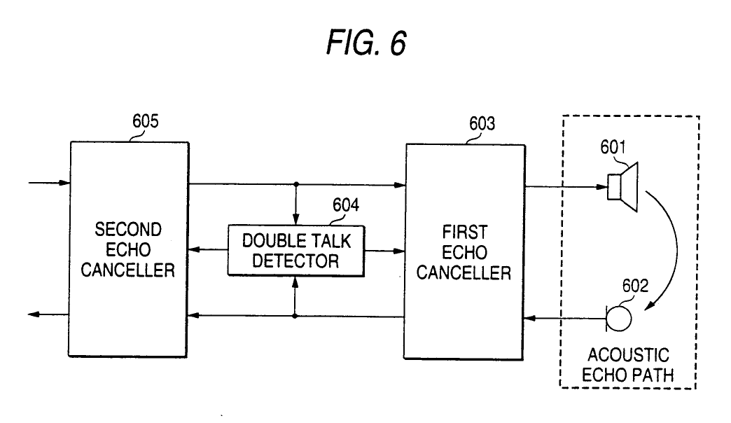

The related art echo cancellation technique is described below. FIG. 6 is a functional block diagram showing related art echo-canceling apparatus.

In FIG. 6, a numeral 601 represents a loudspeaker for regenerating a received voice (voice from a far-end speaker) on a speaker phone telephone set, 602 a microphone for picking up the transmitted voice (voice from a near-end speaker), 603 a first echo canceller for canceling the echo propagated over a direct transmission path, 604 a double-talk detector for detecting a double-talk state by using an output signal from the first echo canceller 603, and 605 a second echo canceller for canceling the echo propagated over an indirect transmission path.

The above echo-canceling apparatus may fail to deliver its full performance and become unstable depending on the surrounding noise. As a result, it is difficult to set the learning timing of the first echo canceller, which results in the unstable behavior at the start of conversation. Further, it is difficult to radically suppress singing and automatic recovery is disabled thus releasing an ongoing call.

### SUMARRY OF THE INVENTION

In view of the aforementioned problems, the invention aims at providing echo-canceling apparatus which allows conversation immediately following a singing and which delivers a favorable echo cancellation performance from the start of conversation, an echo-canceling method for the echo-canceling apparatus as well as a program for the echo-canceling apparatus and a computer-readable recording medium on which the program is recorded.

In order to solve the problems, the echo-canceling apparatus of the invention comprises a loudspeaker which outputs a received voice from a far-end speaker, a microphone to which the voice of a near-end speaker is input, and a CPU which controls the whole system, characterized in that the CPU comprises transfer function estimation means which estimates the transfer function of the acoustic echo path between a loudspeaker and a microphone, first filter means which operates using the transfer function estimated by the transfer function estimation means, first subtraction means which subtracts the output signal of the first filter means from the signal from the microphone, second filter means which operates using the transfer function copied from the first filter means in case the estimation accuracy of the transfer function estimation means is high, second subtraction means which subtracts the output signal of the second filter means from the signal from the microphone, singing detection means which detects singing, notch filter means which notches a specific frequency band component in the signal received from a far-end speaker, and switch means which selects between the signal from the far-end speaker processed by the notch filter means and the signal from the far-end speaker not processed by the notch filter means. This provides echo-canceling apparatus which allows conversation immediately following a singing event and which delivers a favorable echo cancellation performance from the start of conversation.

### BRIEF DESCRIPTION OF THE DRAWIINGS

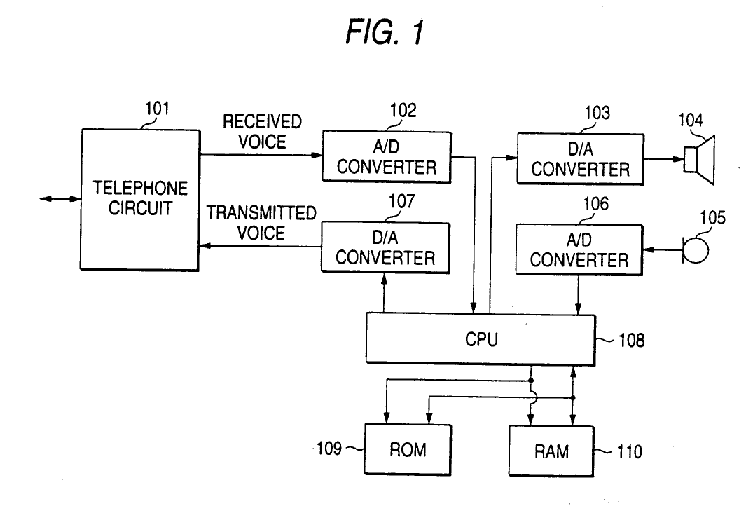

FIG. 1 is a block diagram showing the basic configuration of echo-canceling apparatus according to Embodiment 1 of the invention;

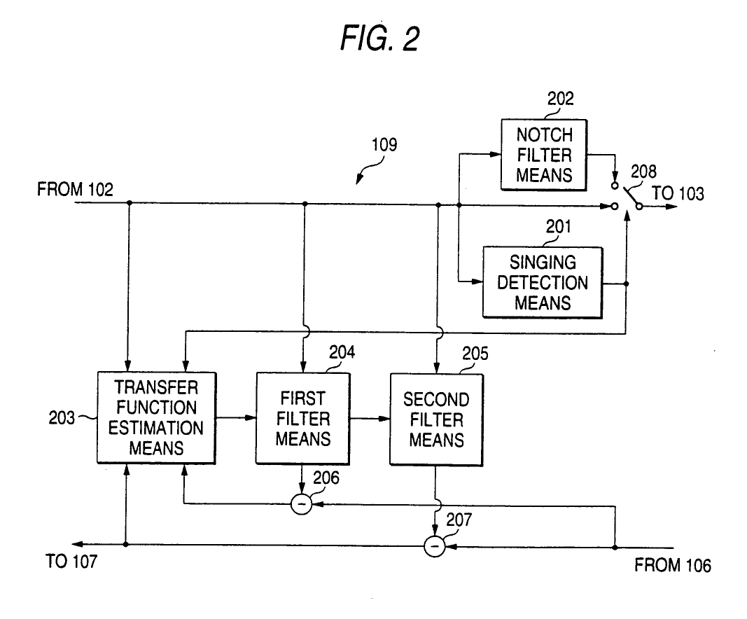

FIG. 2 is a block diagram showing the CPU of echo-canceling apparatus according to Embodiment 1 of the invention;

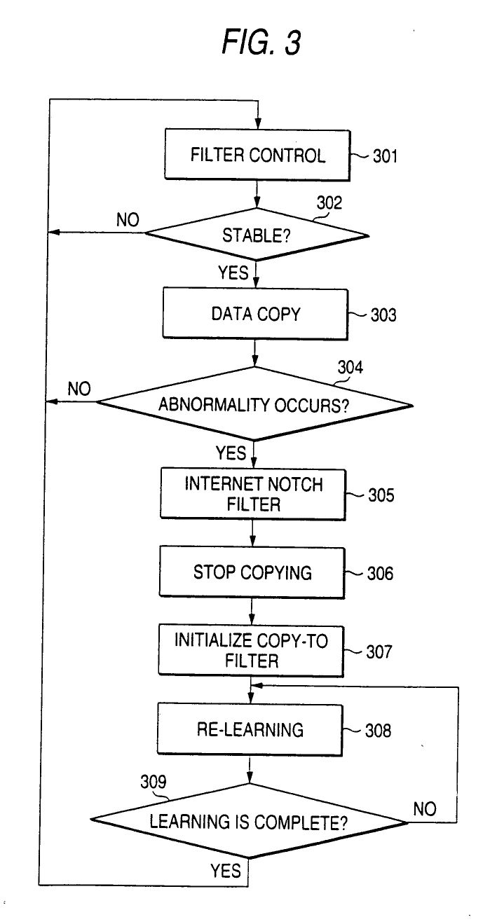

FIG. 3 is a flowchart showing the operation of the CPU in FIG. 2;

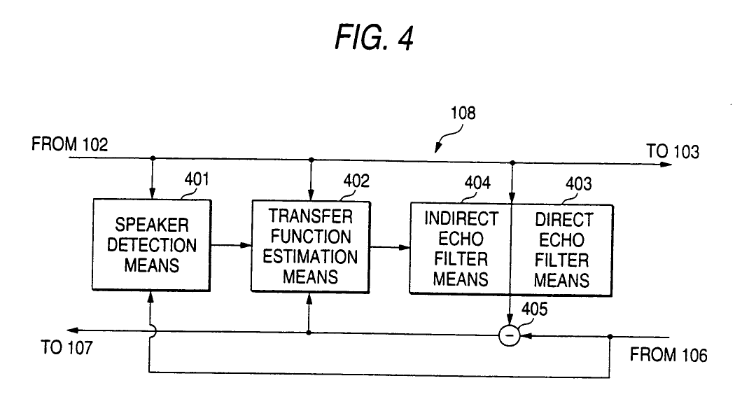

FIG. 4 is a block diagram showing the CPU of echo-canceling apparatus according to Embodiment 2 of the invention;

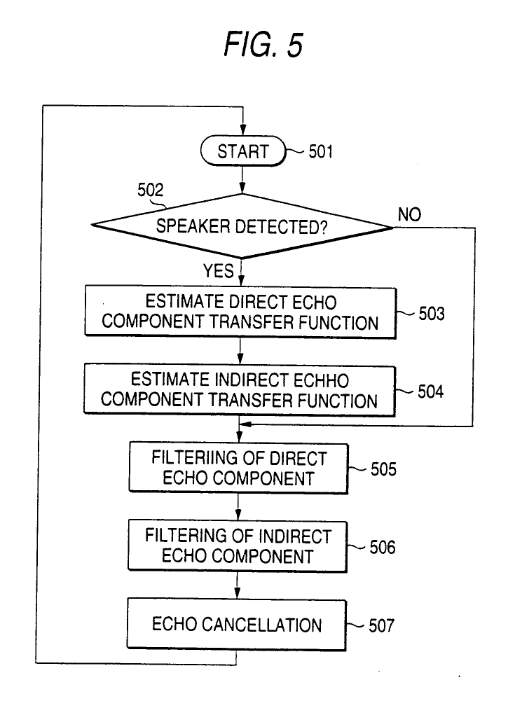

FIG. 5 is a flowchart showing the operation of the CPU in FIG. 4; and

FIG. 6 is a block diagram showing related art echo-canceling apparatus.

### DESCRIPTION OF THE PREFERRED EMBODIMENT

Embodiments of the invention are described below with reference to FIGS. 1 through 5.

(Embodiment 1)

FIG. 1 is a block diagram showing the basic configuration of echo-canceling apparatus according to Embodiment 1 of the invention. FIG. 2 is a block diagram showing the CPU of echo-canceling apparatus according to Embodiment 1 of the invention. FIG. 2 shows an echo-canceling method for the echo-canceling apparatus according to Embodiment 1 of the invention. FIG. 3 is a flowchart showing the operation of the CPU in FIG. 2. This feature shows the outline of a program recorded on a ROM.

In FIG. 1, a numeral 101 represents a telephone circuit having an interface to a telephone line, 102 an A/D converter for converting received voice electric signal as an analog electric signal to a digital electric signal, 103 a D/A converter for converting a digital electric signal to an analog electric signal, 104 a loudspeaker for converting an analog electric signal from the D/A converter 103 to a voice, 105 a microphone for converting a voice to an analog electric signal, 106 an A/D converter for converting an analog electric signal from the microphone 105 to a digital electric signal, 107 a D/A converter for converting a digital electric signal to an analog electric signal (transmitted voice electric signal), 108 a CPU for performing digital processing on a digital electric signal from the A/D converter 102 and the A/D converter 106 and outputting the operation result to the D/A converter 103 and the D/A converter 107, 109 a Read-Only Memory (ROM) where a program to operate the CPU 108 is stored, 110 a Random Access Memory (RAM) used by the CPU 108 as it operates in accordance with the program stored in the ROM 109.

In FIG. 2, a numeral 201 represents singing detection means for detecting singing. The singing detection means 201, detecting a frequency band having a protruding section in the frequency spectrum of a signal from a far-end speaker (hereinafter referred to as a received voice), determines that singing has been made in the frequency band having the protruding section. A numeral 202 represents notch filter means of the band stop type for notching a specific frequency band component, 203 transfer function estimation means for estimating an impulse response of the acoustic echo path between the loudspeaker 104 and the microphone 105 by way of the Steepest Descent Method such as the normalized Least Mean Square (NLMS) method, 204, 205 first and second filter means for performing convolutional operation of the estimated impulse response and the received voice, 206, 207 first and second subtraction means for subtracting the output signals of the first and second filter means from the signal received from the near-end speaker (hereinafter referred to as a transmitted voice), and 208 switch means for selecting whether the received voice will pass through the notch filter means 202 based on the detection result of the singing detection means 201.

Operation of the CPU 108 thus configured is described below referring to FIG. 3.

In FIG. 3, the transfer function estimation means 203 estimates an impulse response and outputs the estimated response to the first filter means 204. The first filter means 204 performs convolutional operation of the impulse response input from the transfer function estimation means 203 and the received voice, and outputs the operation result to the first subtraction means 206. The first subtraction means 206 subtracts the operation result input from the first filter means 204 from the transmitted voice input from the microphone 105 and outputs the subtraction result to the transfer function estimation means 203 (step 301). The transfer function estimation means 203 monitors the subtraction result input from the first subtraction means 206 (step 302).

In case the estimation accuracy of the transfer function estimation means 203 is low and the subtraction result input from the first subtraction means 206 is unstable, execution returns to step 301.

On the other hand, in case the estimation accuracy of the transfer function estimation means 203 is high and the subtraction result input from the first subtraction means 206 is stable, the second filter means 205 copies and stores a filter coefficient representing an impulse response used by the first filter means 204 (step 303).

In case the singing detection means 201 has performed singing detection (step 304) and has not detected singing, execution returns to step 301. The second filter means 205 uses the filter coefficient stored in step 303 to perform convolutional operation of the impulse response and the received voice, and outputs the result of convolutional operation to the second subtraction means 207. The second subtraction means 207 subtracts the operation result input from the second filter means 205 from the transmitted voice input from the microphone 105 and outputs the echo-canceled transmitted voice to the D/A converter toward the far-end speaker.

In case the singing detection means 201 has detected singing, the switch means 208 is switched to the notch filter 202 and the received voice is output to the D/A converter 103 at the near-end speaker via the notch filter means 202 (step 305). Copying of the filter coefficient from the first filter means 204 to the second filter means 205 is stopped by the singing detection means 201 (step 306). The second filter means 205 continues echo cancellation by using a stored filter coefficient before the singing detection means detected singing. The first filter means 204 initializes the filter coefficient (step 307). In case estimation of an impulse response uses a normalized NLMS, initialization of the filter coefficient is resetting the filter coefficient to zero (0). The transfer function estimation means 203 resumes leaning from the state where the filter coefficient of the first filter means 204 is reset to 0 and approximates an impulse response in accordance with the subtraction result of the first subtraction means 206 (step 308). When the learning is complete, execution returns to step 301 (step 309).

The notch filter means 202 may be provided as a frequency-variable type and control may be performed so that the notched frequency band will match the frequency band detected by the singing detection means 201 where singing is made.

While estimation of a transfer function uses the Steepest Decent Method (NLMS) method in this embodiment, other methods may be used to estimate a transfer function.

As mentioned hereinabove, this embodiment comprises transfer function estimation means 203 which estimates the transfer function of the acoustic echo path between a loudspeaker 104 and a microphone 105, first filter means 204 which operates using the transfer function estimated by the transfer function estimation means 203, first subtraction means 206 which subtracts the output signal of the first filter means 204 from the signal from the microphone 105, second filter means 205 which operates using the transfer function copied from the first filter means 204 in case the estimation accuracy of the transfer function estimation means is high, second subtraction means 207 which subtracts the output signal of the second filter means 205 from the signal from the microphone 105, singing detection means 201 which detects singing, notch filter means 202 which notches a specific frequency band component in the signal received from a far-end speaker, and switch means 208 which selects between the signal from the far-end speaker processed by the notch filter means 202 and the signal from the far-end speaker not processed by the notch filter means 202. A singing frequency is filtered out by the notch filter means 202 on detection of singing and the transfer function stored before detection of singing is used to perform echo cancellation. This allows conversation immediately following a singing event. On detection of singing, the transfer function of the first filter means 204 is initialized. The signal from the far-end speaker where a singing frequency component has been removed by the notch filter means 202 is used to learn the transfer function. Once learning of the transfer function is complete, the transfer function is copied from the first filter means 204 to the second filter 205. This delivers a favorable echo cancellation performance from the start of conversation.

Running a program to execute the steps of the echo-canceling method shown in FIG. 3 on a computer allows execution of the echo-canceling method of this embodiment in an arbitrary place at an arbitrary time. By reading on a computer a recording medium where the program is recorded, it is possible to execute the program in an arbitrary place at an arbitrary time.

(Embodiment 2)

FIG. 4 is a functional block diagram showing the CPU of echo-canceling apparatus according to Embodiment 2. FIG. 5 is a flowchart showing the operation of the CPU in FIG. 4. The basic configuration of the echo-canceling apparatus according to this embodiment is the same as that shown in FIG. 1. This feature shows the outline of a program recorded on a ROM.

In FIG. 4, a numeral 401 represents speaker detection means which detects the speech of a far-end speaker, speech of a near-end speaker and a double-talk. (simultaneous speech of the far-end speaker and the near-end speaker), 402 transfer function estimation means which estimates the transfer function of the acoustic echo path between a loudspeaker 104 and a microphone 105 by way of the Steepest Descent Method such as the normalized Least Mean Square (NLMS) method, 403 direct echo filter means which performs convolutional operation of a transfer function corresponding to a direct echo component and a received voice, 404 indirect echo filter means which performs convolutional operation of a transfer function corresponding to an indirect echo component and the received voice, and 405 subtraction means.

The direct echo component refers to a voice emitted from the loudspeaker 104 and directly input to the microphone 105. The indirect echo component refers to a voice emitted from the loudspeaker 104, reflected against objects such as a wall, a floor and a ceiling in an acoustic echo path, and input to the microphone 105.

General operation of the echo-canceling apparatus thus configured is described below referring to FIG. 5.

In FIG. 5, when echo cancellation is started (step 501), the speaker detection means 401 determines whether the talking state is speech of the far-end speaker, speech of the near-end speaker or double talk (step 502). In case the talking state is speech of the far-end speaker, the transfer function estimation means 402 uses an algorithm such as NLMS to estimate a direct echo component transfer function (step 503) and an indirect echo component transfer function (step 504). The direct echo filter means 403 performs convolutional operation of the result of the estimation of direct echo component transfer function (step 503) and a received voice (step 505) while the indirect echo filter means 404 performs convolutional operation of the result of estimation of indirect echo component transfer function (step 504) and the received voice (step 506). The result of convolutional operation is subtracted from the transmitted voice from the microphone 105 on the subtraction means 405 to remove the direct echo component and the indirect echo component (step 507).

This provides echo cancellation which allows high-speed and high-accuracy estimation of a transfer function.

As mentioned hereinabove, according to this embodiment, the direct echo filter means 403 performs convolutional operation of the result of the estimation of direct echo component transfer function (step 503) and a received voice while the indirect echo filter means 404 performs convolutional operation of the result of estimation of indirect echo component transfer function (step 504) and the received voice. The result of convolutional operation is subtracted from the transmitted voice from the microphone 105 on the subtraction means 405 to remove the direct echo component and the indirect echo component. This maintains high the double talk determination accuracy even in case the volume of the voice from the loudspeaker is increased. Double talk detection accuracy is maintained high even in case the voice power ratio of the received voice and the transmitted voice is the same.

### CROSS REFERENCE TO RELATED APPLICATION

This application is based upon and claims the benefit of priority of Japanese Patent Application No2003-066481 filed on Mar. 12, 2003, the contents of which are incorporated herein by reference in its entirety.

What is claimed is:

1. Echo-canceling apparatus comprising a loudspeaker which outputs a received voice from a far-end speaker, a microphone to which the voice of a near-end speaker is input, and a CPU which controls the whole system, wherein:
the CPU comprises transfer function estimation means which estimates the transfer function of the acoustic echo path between a loudspeaker and a microphone,
first filter means which operates using the transfer function estimated by said transfer function estimation means,
first subtraction means which subtracts the output signal of said first filter means from the signal from said microphone,
second filter means which operates using the transfer function copied from said first filter means in case the estimation accuracy of said transfer function estimation means is high,
second subtraction means which subtracts the output signal of said second filter means from the signal from said microphone,
singing detection means which detects singing,
notch filter means which notches a specific frequency band component in the signal received from a far-end speaker, and
switch means which selects between the signal from the far-end speaker processed by said notch filter means and the signal from the far-end speaker not processed by said notch filter means.

2. Echo-canceling apparatus according to claim 1, wherein:
said first subtraction means outputs the subtraction result to said transfer function estimation means; and
said second subtraction means output the subtraction result to the far-end speaker.

3. Echo-canceling apparatus according to claim 2, wherein:
said first filter means and said second filter means perform convolutional operation of a signal from the far-end speaker and a transfer function and outputs the result of the convolutional operation.

4. Echo-canceling apparatus according to claim 2, wherein:
in case said singing detection means has not detected singing,
said second filter means operate using the transfer function copied from said first filter means.

5. Echo-canceling apparatus according to claim 2, wherein:
in case said singing detection means has detected singing,
said singing detection means stops copying of the transfer function from said first filter means to saidsecond filter means and said notch filter means notches the component of the frequency band where singing has been made in a signal from the far-end speaker.

6. Echo-canceling apparatus according to claim 2, wherein:
said singing detection means, detecting a frequency band having a protruding section in the frequency spectrum of a signal to be input, determines that singing has been made in the frequency band having the protruding section.

7. Echo-canceling apparatus according to claim 2, wherein:
saidnotch filter means has a variable frequency band to be notched.

8. Echo-canceling apparatus according to claim 7, wherein:
saidnotch filter means is controlled for the notched frequency band to match the frequency band detected by said singing detection means where singing is made.

9. An echo-canceling method for the echo-canceling apparatus comprising a loudspeaker which outputs a received voice from a far-end speaker, a microphone to which the voice of a near-end speaker is input, and a CPU which controls the whole system, wherein:
the method comprises a transfer function estimation step of estimating the transfer function of the acoustic echo path between a loudspeaker and a microphone,
a first filter step of performing arithmetic operation by using the transfer function estimated in said transfer function estimation step,
a first subtraction step of subtracting the output signal of said first filter step from the signal from said microphone,
a copy step of copying the transfer function used in said first filter step in case the estimation accuracy of said transfer function estimation step is high,
a second subtraction step of subtracting the output signal of said second filter step from the signal from said microphone,
a singing detection step of detecting singing,
a notch filter step of notching a specific frequency band component in the signal received from a far-end speaker, and
a switch step of selecting between the signal from the far-end speaker processed by said notch filter step and the signal from the far-end speaker not processed by said notch filter step.

10. The echo-canceling method according to claim 9, wherein:
said first subtraction step outputs the subtraction result to said transfer function estimation step; and
said second subtraction step outputs the subtraction result to the far-end speaker.

11. The echo-canceling method according to claim 10, wherein:
said first filter step and said second filter step perform convolutional operation of a signal from the far-end speaker and a transfer function and output the result of the convolutional operation.

12. The echo-canceling method according to claim 10, wherein:
in case said the singing detection step has not detected singing,
said second filter step performs arithmetic operation by using the transfer function copied in said copy step.

13. The echo-canceling method according to claim 10, wherein:
in case said singing detection step has detected singing,
said singing detection step stops copying the transfer function used in saidfirst filter step and said notch filter step notches the component of the frequency band where singing has been made in a signal from the far-end speaker.

14. The echo-canceling method according to claim 10, wherein:
said singing detection step, detecting a frequency band having a protruding section in the frequency spectrum of a signal to be input, determines that singing has been made in the frequency band having the protruding section.

15. A program for echo-canceling apparatus comprising a loudspeaker which outputs a received voice from a far-end speaker, a microphone to which the voice of a near-end speaker is input, and a CPU which controls the whole system, wherein:
the program comprises a transfer function estimation step of estimating the transfer function of the acoustic echo path between a loudspeaker and a microphone,
a first filter step of performing arithmetic operation by using the transfer function estimated in said transfer function estimation step,
a first subtraction step of subtracting the output signal of said first filter step from the signal from said microphone,
a copy step of copying the transfer function used in said first filter step in case the estimation accuracy of said transfer function estimation step is high,
a second subtraction step of subtracting the output signal of said second filter step from the signal from said microphone,
a singing detection step of detecting singing,
a notch filter step of notching a specific frequency band component in the signal received from a far-end speaker, and
a switch step of selecting between the signal from the far-end speaker processed by said notch filter step and the signal from the far-end speaker not processed by said notch filter step.

16. The program for the echo-canceling apparatus according to claim 15, wherein:
said first subtraction step outputs the subtraction result to said transfer function estimation step; and
said second subtraction step outputs the subtraction result to the far-end speaker.

17. The program for the echo-canceling apparatus according to claim 16, wherein:
said first filter step and said second filter step perform convolutional operation of a signal from the far-end speaker and a transfer function and output the result of the convolutional operation.

18. The program for the echo-canceling apparatus according to claim 16, wherein:
in case said singing detection step has not detected singing,
said second filter step performs arithmetic operation by using the transfer function copied in saidcopy step.

19. The program for the echo-canceling apparatus according to claim 16, wherein:
in case said singing detection step has detected singing,
said singing detection step stops copying the transfer function used in said first filter step and said notch filter step notches the component of the frequency band where singing has been made in a signal from the far-end speaker.

20. The program for the echo-canceling apparatus according to claim 16, wherein:
said singing detection step, detecting a frequency band having a protruding section in the frequency spectrum of a signal to be input, determines that singing has been made in the frequency band having the protruding section.

21. A computer-readable recording medium on which is recorded a program for the echo-canceling apparatus comprising a loudspeaker which outputs a received voice from a far-end speaker, a microphone to which the voice of a near-end speaker is input, and a CPU which controls the whole system, wherein:
the program comprises a transfer function estimation step of estimating the transfer function of the acoustic echo path between a loudspeaker and a microphone,
a first filter step of performing arithmetic operation by using the transfer function estimated in said transfer function estimation step,
a first subtraction step of subtracting the output signal of saidfirst filter stepfrom said signal from said microphone,
a copy step of copying the transfer function used in saidfirst filter step in case the estimation accuracy of said transfer function estimation step is high,
a second subtraction step of subtracting the output signal of said second filter step from the signal from said microphone,
a singing detection step of detecting singing,
a notch filter step of notching a specific frequency band component in the signal received from a far-end speaker, and
a switch step of selecting between the signal from the far-end speaker processed by said notch filter step and the signal from the far-end speaker not processed by said notch filter step.

22. The computer-readable recording medium on which is recorded a program for the echo-canceling apparatus according to claim 21, wherein:
said first subtraction step outputs the subtraction result to said transfer function estimation step; and
said second subtraction step outputs the subtraction result to the far-end speaker.

23. The computer-readable recording medium on which is recorded a program for the echo-canceling apparatus according to claim 22, wherein:
said first filter step and said second filter step perform convolutional operation of a signal from the far-end speaker and a transfer function and output the result of the convolutional operation.

24. The computer-readable recording medium on which is recorded a program for the echo-canceling apparatus according to claim 22, wherein:
in case said singing detection step has not detected singing,
said second filter step performs arithmetic operation by using the transfer function copied in saidcopy step.

25. The computer-readable recording medium on which is recorded a program for the echo-canceling apparatus according to claim 22, wherein:
in case said singing detection step has detected singing,
said singing detection step stops copying the transfer function used in said first filter step and said notch filter step notches the component of the frequency band where singing has been made in a signal from the far-end speaker.

26. The computer-readable recording medium on which is recorded a program for the echo-canceling apparatus according to claim 22, wherein:
said singing detection step, detecting a frequency band having a protruding section in the frequency spectrum of a signal to be input, determines that singing has been made in the frequency band having the protruding section.
